(19) United States
(12) Patent Application Publication
(10) Pub. No.: US 2010/0140857 A1
(43) Pub. Date: Jun. 10, 2010

(54) Air-Damper Engine Mount

(75) Inventors: Jeong Hoon KIM, Seoul (KR); Jae Yong CHOI, Busan (KR); Shin Won LEE, Busan (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Daeheung R&T Co., LTD., Gimhae-si (KR)

(21) Appl. No.: 12/510,141

(22) Filed: Jul. 27, 2009

(30) Foreign Application Priority Data
Dec. 5, 2008 (KR) 10-2008-0123099

(51) Int. Cl. F16F 9/00

(52) U.S. Cl. 267/140.13

(57) ABSTRACT

An air-damped engine mount may include a main pipe, a main rubber into which a center bolt is fitted, a cover plate having at least an air hole, wherein the cover plate is coupled to a lower portion of the main pipe and the main rubber is coupled to an upper portion of the main pipe to form a damping chamber enclosed by the main rubber, the main pipe and the cover plate, and a membrane mounted on the cover plate to be displaced in response to a deformation of the main rubber.

### CROSS-REFERENCE TO RELATED APPLICATION

The present application claims priority to Korean Patent Application Number 10-2008-123099 filed on Dec. 5, 2008, the entire contents of which application is incorporated herein for all purposes by this reference.

### BACKGROUND OF THE INVENTION

1. Field of the Invention

The present invention relates to an air-damped engine mount, and more particularly, to an air-damped engine mount, wherein a separate membrane is installed in a cover plate, which is coupled to one side of a main pipe to form a damping chamber inside the engine mount, in addition to an air hole formed in the cover plate in order to damp down engine vibration through a displacement of the membrane as well as improving damping performance in a high frequency range of the engine vibration, which is different from a frequency range of the engine vibration reduced by the air hole, and the cover plate is double-bent to improve the damping performance as well as durability.

2. Description of Related Art

Engine mounts generally used to fix an engine to a frame of a vehicle have functions of not only connecting and supporting the engine to the vehicle frame but also absorbing vibration and noise produced from the engine, which would otherwise be transmitted to the vehicle frame without being reduced.

As conventional engine mounts having those functions, a fluid-filled engine mount (or hydraulic engine mount) and a rubber engine mount are widely used. The fluid-filled engine mount defines therein a fluid chamber filled with fluid such as oil. The rubber mount does not define therein the fluid chamber, with its entire body made of solid rubber.

The rubber engine mount made of solid rubber consists of a small number of parts, leading to merits such as a simple fabrication process and a cheap cost. However, the problems of the rubber engine mount are that it cannot sufficiently absorb vibration and noise due to poor damping efficiency.

The fluid-filled engine mount defining therein the fluid chamber filled with fluid can sufficiently absorb vibration and noise due to high damping efficiency. However, the fluid-filled engine mount have problems such as a complicated fabrication process and a considerably expensive cost since a fluid-encapsulating structure is required.

Recently, an air-damped engine mount using air pressure has been developed in order to overcome the drawbacks of the fluid-filled engine mount or the rubber mount.

FIG. 1 is a schematic cross-sectional view illustrating the structure of a typical air-damped engine mount of the related art.

As shown in FIG. 1, the typical air-damped engine mount of the related art includes a main rubber 20 into which the center bolt 10 is fitted, the main rubber 20 elastically supporting the center bolt 10 to be coupled to an engine of a vehicle, a hollow main pipe 30 supporting the main rubber 20 and tightly coupled to the main rubber 20, and a cover plate 40 tightly coupled to one end of the main pipe 30 to form a damping chamber 50 in a space defined between the main rubber 20 and the cover plate 40. The cover plate 40 is mounted on one end of the main pipe 30 by riveting to the main rubber 20.

The cover plate 40 has an air hole 41 allowing the damping chamber 50 to communicate with the outside. Specifically, outside air enters the damping chamber 50 through the air hole 41 or inside air exits the damping chamber 50 through the air hole 41.

The vibration of the main rubber 20 is damped down while the air in the damping chamber is exiting to or entering from the outside. When the shape of the main rubber 20 is changed by the engine vibration, the air circulates along the air hole 42 due to the inside pressure of the damping chamber 50. At this time, the vibration is damped down by the pressure changes and the flow resistance.

The air entering or exiting the damping chamber 50 serves to reduce the vibration of the main rubber 20. In more detail, the main rubber 20 changes the pressure inside the damping chamber 50 when deformed by the vibration of the engine, so that the air exits or enters through the air hole 41. The exiting or entering air causes flow resistance, which in turn instantaneously reduces the vibration of the main rubber.

In the air-damped engine mount configured like this, there has been a problem of unsatisfactory vibration damping performance on the engine since the air directly circulates with the outside via the air hole 41 and the flow resistance of the exiting or entering air is very small due to the characteristic of the air. In addition, since the flow resistance of the air passing through the air hole 41 is mainly generated when low frequency vibration is produced, the damping performance is rather insignificant for high frequency vibration. Accordingly, the engine vibration is transmitted to the vehicle frame thereby degrading ride comfort.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an air-damped engine mount, wherein a separate membrane is installed in a cover plate, which is coupled to one side of a main pipe to form a damping chamber inside the engine mount, in addition an air hole formed in the cover plate in order to damp down engine vibration through a displacement of the membrane as well as improving damping performance in a high frequency range of the engine vibration, which is different from a frequency range of the engine vibration reduced by the air hole, and the cover plate is double-bent to improve the damping performance as well as durability.

In an exemplary embodiment of the present invention, the air-damped engine mount may include a main pipe, a main rubber into which a center bolt is fitted, a cover plate having at least an air hole, wherein the cover plate is coupled to a lower portion of the main pipe and the main rubber is coupled to an upper portion of the main pipe to form a damping chamber enclosed by the main rubber, the main pipe and the cover plate, and a membrane mounted on the cover plate to be displaced in response to a deformation of the main rubber.

The membrane may be made of rubber.

The cover plate may have an opening, and the membrane may be tightly coupled to the cover plate by being fitted into the opening such that a circumferential portion of the membrane is fixed on the cover plate and a central portion of the membrane is displaced by an upward or downward deformation in response to the deformation of the main rubber.

In another aspect of the present invention, the opening of the cover plate may be formed in a central portion thereof.

The cover plate mounted on the lower portion of the main pipe may be coupled to the main rubber by curling.

The cover plate may be double-bent inwards in a circumferential portion, and the double-bent circumferential portion may be coupled to the lower portion of the main pipe.

In an exemplary embodiment of the present invention, the air-damped engine mount may include a main pipe, a main rubber into which a center bolt is fitted, a cover plate having an air hole, wherein the cover plate is coupled to a lower portion of the main rubber and the main rubber is coupled to an upper portion of the main rubber to form a damping chamber inside the engine mount, and a membrane mounted on the cover plate to be displaced in response to a deformation of the main rubber.

According to exemplary embodiments of the present invention as set forth above, the separate membrane is installed in the cover plate, which is coupled to one side of the main pipe to form the damping chamber inside the engine mount, in addition the air hole formed in the cover plate in order to damp down engine vibration through a displacement of the membrane as well as improving damping performance in a high frequency range of the engine vibration, which is different from a frequency range of the engine vibration reduced by the air hole, and the cover plate is double-bent to improve the damping performance as well as durability.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic cross-sectional view illustrating the structure of a typical air-damped engine mount of the related art.

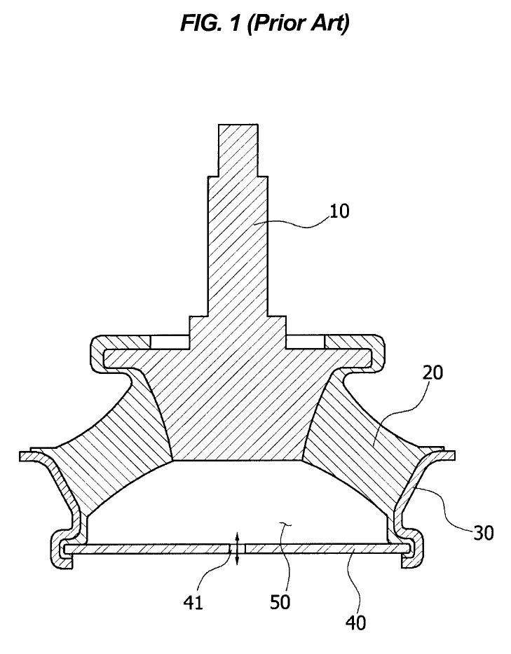

FIG. 2 is a schematic cross-sectional view illustrating the internal structure of an exemplary air-damped engine mount in accordance with the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

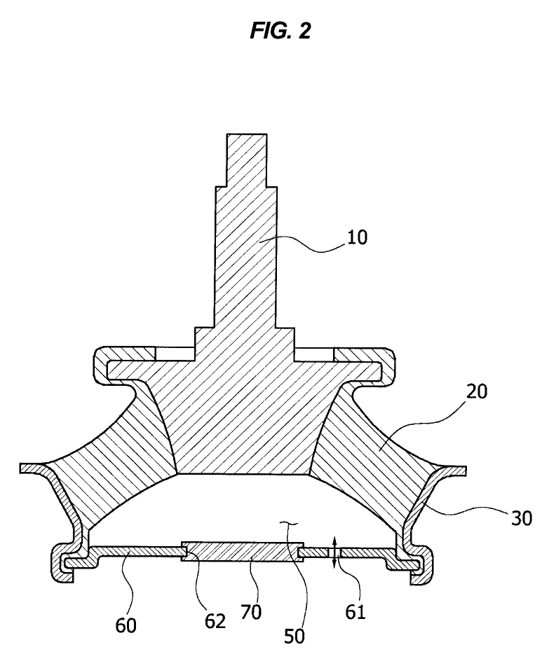

FIG. 2 is a schematic cross-sectional view illustrating the internal structure of an air-damped engine mount in accordance with various embodiments of the present invention.

As shown in FIG. 2, the air-damped engine mount according to various embodiments of the present invention includes a main rubber 20 coupled to the top portion of a main pipe 30, a cover plate 60 coupled to the bottom portion of the main pipe 30, and a damping chamber 50 formed inside a space defined by the main rubber 20, the cover plate 60 and the main pipe 30.

A center bolt 10 is coupled to the central portion of the main rubber 20 by means of curing-bonding and the like, and is designed to be coupled to and supported by an engine of a vehicle. An air hole 61 is formed in the cover plate 60 to connect the damping chamber 50 with the outside such that the air can exit and enter the damping chamber 50.

In the mean time, as shown in FIG. 2, a membrane 70 may be installed in the central portion of the cover plate 60. The membrane 70 is constructed to be displaced in response to a deformation of the main rubber 20 when vibration occurs in the engine.

Once the engine vibration is transmitted to the main rubber 20 through the center bolt 10 coupled to the engine, the engine vibration is primarily damped down by the elasticity of the main rubber 20. At this time, the engine vibration causes a displacement of the main rubber 20. Since the displacement of the main rubber 20 changes the space volume inside the damping chamber 50, the inside pressure of the damping chamber 50 changes so that the air accordingly exits the damping chamber 50 to the outside via the air hole 61 of the cover plate 60 or vice versa. Since the air-damped engine mount according to various embodiments of the present invention is provided with the separate membrane 70 in the cover plate 60, the air exits or enters the damping chamber 50 via the air hole 61 in response to a change in the inside pressure of the damping chamber 50, and at the same time, an upward and downward displacement occurs in the membrane 70 in response to the change in the inside pressure.

The internal volume of the damping chamber 50 is changed again in response to the displacement of the membrane 70. The internal pressure of the damping chamber 50 is accordingly changed to neutralize the change in the internal pressure caused by the engine vibration. Therefore, the air-damped engine mount according to various embodiments of the present invention is constructed to damp down the engine vibration by neutralizing the change in the internal pressure using the displacement of the membrane 70 occurring along with the displacement of the main rubber 20.

The displacement of the membrane 70 is required to occur almost at the same time or consecutively in response to the displacement of the main rubber 20. For this, the membrane 70 has to be designed to be easily displaced. In various embodiments of the present invention, the membrane 70 can be made of soft elastic rubber material.

The frequency range of the engine vibration neutralized by the displacement of the membrane 70 can be determined to be different from the frequency range of the engine vibration neutralized by the flow resistance of the air passing through the air hole 61. The frequency range of the engine vibration neutralized by the flow resistance of the air passing through the air hole 61 as in the normal air-damped engine mount of the related art can be determined to be a low frequency range, and the frequency range of the engine vibration neutralized by the displacement of the membrane 70 can be determined to be a relatively-high frequency range.

Therefore, the air-damped engine mount according to various embodiments of the present invention can neutralize engine vibration in two different frequency ranges unlike the related art, and in particular, can smoothly damp down the engine vibration in the high frequency range.

In the meantime, referring to a method of mounting the membrane 70 on the cover plate 60, an opening 62 is formed in the central area of the cover plate 60 as shown in FIG. 2, and the membrane 70 is mounted on the cover plate 60. Here, the membrane 70 can be fitted into the opening 62 and be tightly coupled to the cover plate 60. According to this coupling structure, the circumferential portion of the membrane 70 coupled to the opening 62 can be fixed and the central portion of the membrane 70 can be deformed up and down. Accordingly, a displacement easily occurs in the membrane 70.

Further, in various embodiments of the present invention, the cover plate 60 can be mounted on one side of the main pipe 30 as coupled to the main rubber 20 through curling and unlike the related art. Since this coupling method through the curling improves coupling force to ensure tight contact and facilitates coupling compared to the rivet coupling method of the related art, the air-damped engine mount with this coupling method can improve durability and facilitate fabrication.

Next, referring to the relation between the shape and the performance of the air-damped engine mount, the performance of the air-damped engine mount is highly dependent upon the shape of the damping chamber 50. In order to circulate much more air on the same displacement, the area of the main rubber 20 and the cover plate forming the damping chamber 50 is required to be larger, and the height of the damping chamber 50 is required to be lower. Therefore, the air-damped engine mount according to various embodiments of the present invention can be designed to lower the height of the damping chamber 50 and increase the area of the cover plate 60 according to the correlation between the shape and the performance. For this purpose, the outer circumferential area of the cover plate 60 is double-bent and is coupled to one side of the main pipe 30 as shown in FIG. 2.

Comparing the cover plate 60 having this double-bent shape with a plain cover plate having the same size, as shown in FIG. 2, the horizontal cross-sectional area of the double-bent cover plate 60 forming the damping chamber 50 is not substantially reduced and is thus almost the same as that of the plain cover plate. However, the height of the damping chamber 50 can be more reduced compared to the horizontal cross-sectional area of the cover plate 60. Accordingly, damping performance can be further improved without expanding the cover plate 60.

For convenience in explanation and accurate definition in the appended claims, the terms “top”, “bottom”, “upper”, and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. An air-damped engine mount, comprising:
a main pipe;
a main rubber into which a center bolt is fitted;
a cover plate having at least an air hole, wherein the cover plate is coupled to a lower portion of the main pipe and the main rubber is coupled to an upper portion of the main pipe to form a damping chamber enclosed by the main rubber, the main pipe and the cover plate; and
a membrane mounted on the cover plate to be displaced in response to a deformation of the main rubber.

2. The air-damped engine mount according to claim 1, wherein the membrane is made of rubber.

3. The air-damped engine mount according to claim 1, wherein
the cover plate has an opening, and
the membrane is tightly coupled to the cover plate by being fitted into the opening such that a circumferential portion of the membrane is fixed on the cover plate and a central portion of the membrane is displaced by an upward or downward deformation in response to the deformation of the main rubber.

4. The air-damped engine mount according to claim 3, wherein the opening of the cover plate is formed in a central portion thereof.

5. The air-damped engine mount according to claim 1, wherein the cover plate mounted on the lower portion of the main pipe is coupled to the main rubber by curling.

6. The air-damped engine mount according to claim 1, wherein the cover plate is double-bent inwards in a circumferential portion, and the double-bent circumferential portion is coupled to the lower portion of the main pipe.
